(19) United States
(12) Patent Application Publication
(10) Pub. No.: US 2016/0163430 A1
(43) Pub. Date: Jun. 9, 2016

(54) WIND TURBINE

(71) Applicant: WOBBEN PROPERTIES GMBH, Aurich (DE)

(72) Inventors: Gerd BERENTS, Aurich (DE); Simon SCHROBSDORFF, Eversmeer (DE)

(21) Appl. No.: 14/900,988

(22) PCT Filed: Jun. 16, 2014
(86) PCT No.: PCT/EP2014/062531

§ 371 Date: Dec. 22, 2015

(30) Foreign Application Priority Data
Jun. 24, 2013 (DE) 10 2013 211 898.8

(51) Int. Cl. H01C 7/10; F03D 9/00

(52) U.S. Cl. CPC H01C 7/10; F03D 11/00; F03D 9/002; F03D 9/006

(57) ABSTRACT

A wind turbine is provided which comprises a rotor comprising at least two rotor blades, an electric generator, which is coupled directly or indirectly to the rotor and generates an electric power, and at least one power electronics unit, which is provided for converting an input voltage with an input frequency into an output voltage with an output frequency. The at least one power electronics unit has at least one varistor unit. The at least one varistor unit has at least one varistor disc with a voltage-dependent resistance and at least one metal disc that is provided in contact with the at least one varistor disc and is a cooling element for cooling the at least one varistor disc.

### BACKGROUND

1. Technical Field

The present invention relates to a wind turbine.

2. Description of the Related Art

Wind turbines have an aerodynamic rotor typically comprising three rotor blades, which set the rotor in rotary motion as long as there is wind. The rotor is coupled directly or indirectly to an electric generator, which generates an electric power when the rotor sets the electric generator in motion. In certain operating states of the wind turbine, it may arise that voltage spikes occur at the generator output.

In the German patent application forming the basis for priority, the German Patent and Trademarks Office found the following documents: DE 10 2008 049 630 A1; DE 10 2009 004 318 A1 and US 2012/0025804 A1.

### BRIEF SUMMARY

Disclosed is a wind turbine capable of converting excess electric power generated by the electric generator efficiently into heat. In order to reduce the impact of voltage spikes, excess electrical energy can be converted into heat by load resistors.

A wind turbine is provided which comprises a rotor comprising at least two rotor blades, an electric generator, which is coupled directly or indirectly to the rotor and generates an electric power, and at least one power electronics unit, which is provided for converting an input voltage with an input frequency into an output voltage with an output frequency. The power electronics unit has at least one varistor unit. The varistor unit has at least one varistor disc with a voltage-dependent resistance and at least one metal disc, which is provided in contact with the at least one varistor disc and is provided as cooling element for cooling the varistor disc. The varistor unit can have a voltage-dependent resistance. The at least one metal disc has good thermal conductivity. The good thermal conductivity results in the at least one metal disc being effective when used for cooling the varistor discs.

In accordance with an embodiment, the at least one varistor unit has a housing, and the housing is filled with a potting compound in order to increase the thermal capacity of the varistor unit.

In accordance with another embodiment, a plurality of varistor units are thermally coupled via a bracing element.

In accordance with another embodiment, three varistor units are delta-connected electrically to one another so as to form a three-phase varistor unit.

In accordance with another embodiment, the connection lines for the varistor unit are passed to the outside on one side of the varistor unit.

In certain operating states of the wind turbine, for example in the case of load shedding, voltage spikes can occur at the generator, which can result in damage to the surge arrestors at the generator and other component parts. In order to reduce such voltage spikes at the generator, at least one varistor unit is provided. The varistor unit can be provided, for example, in a nacelle control cabinet.

### BRIEF DESCRIPTION OF THE SEVERAL VIEWS OF THE DRAWINGS

Advantages and exemplary embodiments will be explained in more detail below with reference to the drawings.

FIG. 1 shows a schematic illustration of a wind turbine in accordance with an embodiment,

FIG. 2A shows a schematic illustration of a varistor unit in accordance with an embodiment,

FIG. 2B shows a further schematic illustration of the varistor unit in accordance with an embodiment, and

FIG. 2C shows a top plan view of the varistor unit in accordance with an embodiment.

### DETAILED DESCRIPTION

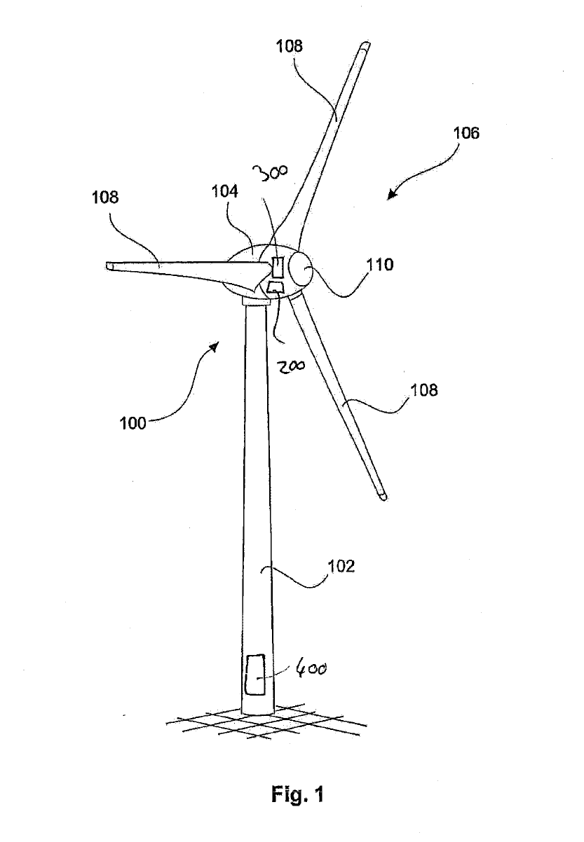

FIG. 1 shows a schematic illustration of a wind turbine in accordance with an embodiment. The wind turbine 100 has a tower 102 and a nacelle 104. A rotor 106 comprising three rotor blades 108 and a spinner 110 is provided on the nacelle 104. The rotor 106 is set in rotary motion by the wind during operation and thus also rotates (directly or indirectly) a rotor or armature of an electric generator 200 in the nacelle 104. A pitch angle of the rotor blades 108 can be varied by pitch motors at the rotor blade roots of the respective rotor blades 108.

An electric generator 200 is provided in the nacelle 104. A first power electronics unit 300 can be provided in the nacelle 104, and a second power electronics unit 400 can be provided in the base region of the tower 102. The first power electronics unit 300 may be a rectifier, for example. The first power electronics unit may also be a nacelle control cabinet or a filter unit.

The second power electronics unit 400 can be an inverter, for example.

The first and/or second power electronics unit 300, 400 can have at least one varistor unit in accordance with one embodiment.

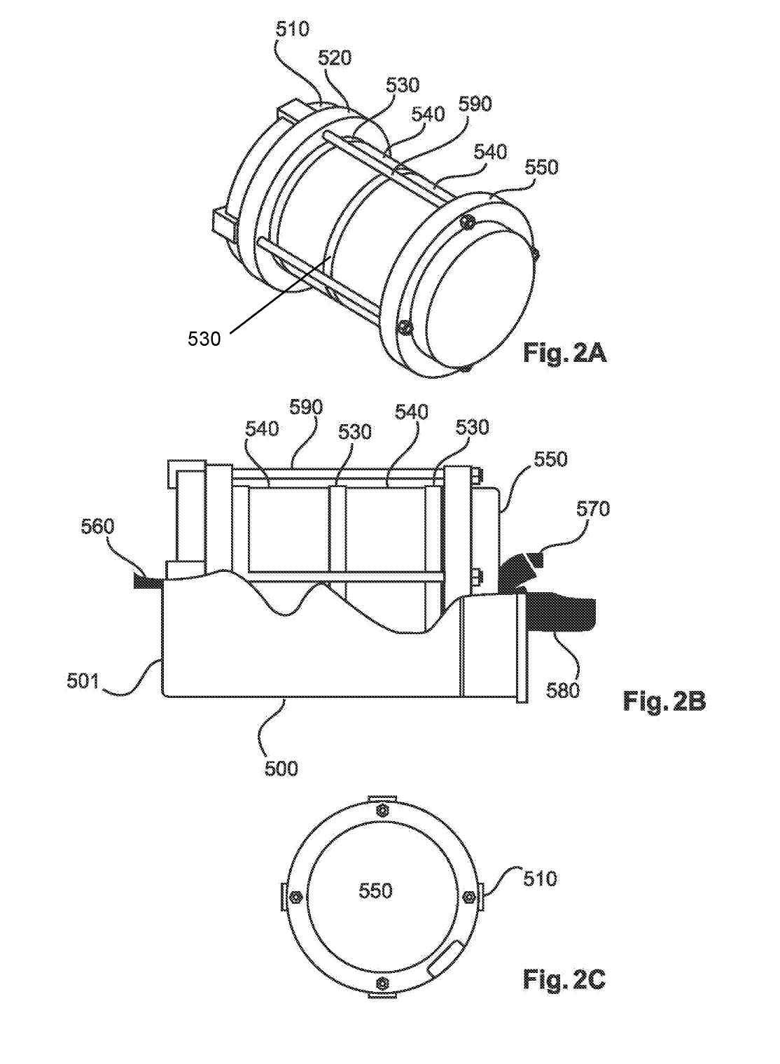

FIG. 2A shows a schematic illustration of a varistor unit in accordance with an embodiment. The varistor unit 500 in accordance with the embodiment can be provided in the first and/or second power electronics unit 300, and can convert electric power into heat.

The varistor unit 500 has, on its first side, an insulator 510, a first metal disc 520, a first varistor disc 530, a second metal disc 540, a second varistor disc 530, a third metal disc 540 and a fourth metal disc 550. The fourth metal disc 550 can also act as a cover. In accordance with the embodiment, therefore, the varistor discs 530 are always in contact with at least one metal disc, preferably with two metal discs, and the varistor discs 530 can have voltage-dependent resistances. The second and third metal discs 540 have a thickness which is greater than the thickness of the varistor discs 530. The second and third metal discs 540 are preferably made from a metal which has good thermal conductivity. Preferably, a volume of the second and third metal discs 540 is substantially greater than a volume of the varistor discs 530. The first, second, third and fourth metal discs 520, 540, 550 and the varistor discs 530 can be fastened to one another, for example by means of rods 590, where the rods 590 are screwed on the first and fourth metal discs 520, 550 and where the varistor discs 530 and the second and third metal discs 540 are arranged stacked therebetween.

FIG. 2B shows a schematic illustration of the varistor unit in accordance with an embodiment. In addition to the illustration shown in FIG. 2A, a housing 501 is also illustrated, at least partially. This housing 501 can have a cylindrical configuration, for example. The varistor unit is positioned within the housing, and the housing 501 can then be filled by means of a potting compound, which is likewise advantageous as it increases thermal capacity.

In FIG. 2B, connection lines 570 and optional connection terminals 580 are likewise shown.

FIG. 2C shows a top plan view of the varistor unit in accordance with an embodiment. In this case, in particular the fourth metal disc 550 can be seen.

Owing to the use of the varistor unit in the first power electronics unit 300, which is connected, for example, to the connection terminals of the generator 200, high-energy surges at the generator output terminals can be limited. In particular, the compact design of the varistor unit is advantageous in that it can be built into already existing power cabinets or power electronics units.

The connection of the above-described varistor unit can be directly made to the wired electric grid.

By virtue of the coupling of the varistor discs 530 to metal discs 540, thermal coupling can be achieved, with the result that the heat generated by the varistor discs 530 can be transferred to the metal discs 540. Thus, the thermal capacity of the respective varistor units 500 can be considerably increased resulting in improved heat dissipation.

By virtue of the use of the varistor units, the wind turbine can respond very quickly to load shedding, for example. Directly after load shedding, the electric power generated by the generator can be converted into heat via the varistor units. By virtue of the use of the varistor units, a time segment (or the electric power generated in this time segment) up to which the pitch angle of the rotor blades can be changed and the power generated by the electric generator can be reduced can be covered. In this time span up to which the electric power generated by the generator can be reduced, the varistor units according to the invention can be used to convert the generated power at least temporarily into heat.

The metal discs which are in contact with the varistor discs may have a large volume such that the metal discs have a high thermal capacity. As a result, the heat generated in the varistor discs can be transferred quickly to the metal discs. Owing to the high thermal capacity of the varistor units, the varistor units can also be activated more quickly again since the varistor discs cool down more quickly.

The varistor discs have a voltage-dependent resistance.

1. A wind turbine, comprising
a rotor comprising at least two rotor blades,
an electric generator that is coupled to the rotor and that generates electric power, and
at least one power electronics unit for converting an input voltage with an input frequency into an output voltage with an output frequency,
wherein the at least one power electronics unit has at least one varistor unit,
wherein the at least one varistor unit includes:
at least one varistor having a voltage-dependent resistance, and
at least one metal disc in direct contact with the at least one varistor disc, the at least one metal disc being a as cooling element for cooling the at least one varistor disc.

2. The wind turbine according to claim 1 wherein
the at least one varistor unit is in a housing that surrounds the at least one varistor disc and the at least one metal disc,
wherein the housing is filled with a potting compound thereby increasing a thermal capacity of the at least one varistor unit.

3. The wind turbine according to claim 1 wherein a thickness of the at least one metal disc is greater than a thickness of the at least one varistor disc.

4. The wind turbine according to claim 1 wherein a volume of the at least one metal disc is greater than a volume of the at least one varistor disc.

5. The wind turbine according to claim 1 wherein the at least one varistor unit is a first varistor unit and wherein the at least one power electronics unit includes three varistor units that include the first varistor unit, a second varistor unit and a third varistor unit that are delta-connected electrically to one another thereby forming a three-phase varistor unit.

6. A wind turbine power electronics unit comprising
at least one varistor unit including at least one varistor disc having a voltage-dependent resistance and at least one metal disc in direct contact with the at least one varistor disc, the at least one metal disc being a cooling element for cooling the at least varistor disc.

7. The wind turbine according to claim 1 wherein the electric generator is coupled directly to the rotor.

8. The wind turbine according to claim 1 wherein the at least one varistor unit includes a first varistor disc and first and second metal discs, the first varistor disc and the first and second metal discs being stacked, the first varistor disc being between the first and second metal discs.
